(19) United States
(12) Patent Application Publication
(10) Pub. No.: US 2026/0338014 A1
(43) Pub. Date: Oct. 29, 2026

(54) VEHICLE DOOR WITH A WING HANDLE SYSTEM

(71) Applicant: MINEBEA MITSUMI Inc., Nagano-ken (JP)

(72) Inventors: Thomas PEYNOT, Pianezza (IT); Sachin SHARMA, Pianezza (IT); Piyush BHALLA, Pianezza (IT)

(73) Assignee: MINEBEA MITSUMI Inc., Nagano-ken (JP)

(21) Appl. No.: 19/653,413

(22) Filed: Apr. 21, 2026

(30) Foreign Application Priority Data
Apr. 29, 2025 (EP) 25173362.2

(51) Int. Cl. E05B 85/18

(52) U.S. Cl. CPC E05B 85/18

(57) ABSTRACT

A vehicle door includes a window lower belt, an opening and a door handle system with a wing handle movable between a retracted position and a deployed position. In the retracted position, the handle is retracted through an opening in the vehicle door, and the handle is configured to be flush with the window lower belt. In the deployed position, the handle is protruding outwardly from the opening with respect to the window lower belt. The door handle system includes an intermediate piece fixed to the handle and an actuator for moving in translation a link arm which is urged against the intermediate piece by an elastic element, such that a free end of the handle in its retracted position is movable in rotation against an elastic force exerted by the elastic element.

### CROSS-REFERENCE TO RELATED APPLICATIONS

This application claims priority to and the benefit of EP 25173362.2 filed on Apr. 29, 2025. The disclosure of the above application is incorporated herein by reference.

### FIELD

The present disclosure relates to the field of door handles for motor vehicles, and more particularly to wing handles.

### BACKGROUND

The statements in this section merely provide background information related to the present disclosure and may not constitute prior art.

Wing handles have a generally flat design and an elongated shape and are arranged aligned with a window lower belt of the vehicle door. Known wing handles protrude outwardly and generate air flow turbulences that may reduce vehicle autonomy, by increasing fuel consumption or draining the battery faster, and may increase aerodynamic noise, which is especially relevant for electrical vehicles. Being in constant protrusion with respect to the vehicle door, known wing handles also create a design disruption, which may be considered unsightly.

Besides, vehicle doors generally have a tapered profile from bottom to top, whereby room within the vehicle door may be insufficient to incorporate the operating mechanism of a wing handle. In addition, in winter conditions, ice can block the handle, thus preventing the handle to operate properly. Further, since a part of the mechanism of the wing handle is housed inside the vehicle door, whereas the handle is necessarily outside the door, an opening in the door panel is required. However due to the presence of such an opening which can be visible in some position of the handle, foreign bodies such as dust and small objects can be inserted into or fall through the opening inside the vehicle door. Thus, electrical or mechanical parts of the wing handle system which are accessible from the opening can be damaged.

Thus, there is a need for a compact, robust and aesthetical vehicle door handle system that possibly does not protrude outwardly, while being adaptable to a broad number of implementations and vehicle designs.

### SUMMARY

This section provides a general summary of the disclosure and is not a comprehensive disclosure of its full scope or all of its features.

The present disclosure is related to a vehicle door comprising a window lower belt, an opening, and a door handle system comprising a wing handle movable between a retracted position and a deployed position, wherein: in the retracted position, the wing handle is configured to be at least partially retracted through an opening in the vehicle door, the wing handle having an outer surface configured to be flush with an outer surface of the window lower belt, and in the deployed position, the wing handle is configured to be protruding outwardly from the opening with respect to the outer surface of the window lower belt, the door handle system further comprises an intermediate piece fixed to the wing handle and an actuator for moving in translation a link arm which is urged against the intermediate piece by an elastic element, such that a free end of the wing handle in its retracted position is movable in rotation against an elastic force exerted by the elastic element.

In this manner, in winter conditions, the user can break the ice that can block the wing handle merely by pushing the free end of the handle downwards or pulling the latter upwards, against the elastic force exerted by the elastic element.

According to an embodiment, the door handle system comprises an actuator configured to cause the wing handle to move between the retracted position and the deployed position, the movement of the wing handle between the retracted position and the deployed position comprising a translation movement between the retracted position and an intermediate extended position and a rotation movement between the intermediate extended position and the deployed position.

According to an embodiment, the vehicle door further comprises a cover fixed to and closing at least partially the opening, the cover comprising a rigid part, at least one flexible flap fixed to the rigid part, the flexible flap having a rest position when the wing handle is in the retracted position and a raised position, the flexible flap being raised by the wing handle when the wing handle is moved to the deployed position.

Such a cover inhibits foreign objects from being inadvertently introduced through the opening into the door. The flexible flap enables to maintain the opening substantially closed even when the wing handle is raised in its deployed position.

According to an embodiment, the wing handle comprises a grip element disposed in the retracted position so as to form a gap between the grip element and the cover, the handle being urged in the retracted position by an elastic element.

In this manner, the handle can be manually moved upwards or downwards to break ice that can block the handle in the retracted position.

According to an embodiment, the cover comprises a rigid part to which the flexible flap is fixed.

According to an embodiment, the cover is formed by overmolding the flexible flap on the rigid part.

According to an embodiment, the cover comprises a soft gasket placed against the door. Thus, the gasket provides a seal between the cover and the door.

According to an embodiment, the cover comprises clips and/or hooks to fix the cover to the door in position on the opening. In this manner, the cover can be easily installed and fixed to the door merely by a single pressing operation.

Embodiments may also relate to a vehicle comprising at least one vehicle door as previously defined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic perspective view of a part of a side door of a vehicle, according to an embodiment;

FIGS. 2A, 2B and 2C are side views of a door handle system, respectively in a retracted position, an extended position and a deployed of the handle, according to an embodiment;

FIGS. 3A and 3B are front views of the door handle system, a push being exerted by a user on the handle in FIG. 3B, according to an embodiment;

FIG. 4 is a schematic back view of the door handle system, when the user presses the handle, according to an embodiment;

FIG. 5 is a schematic perspective view of a part of the side door with the door handle in the deployed position, according to an embodiment;

FIG. 6 is a schematic perspective view of the part of the side door, the door handle being shown transparent by a dashed-line contour in a retracted position on the door and with solid contours spaced apart from the side door, according to an embodiment;

FIG. 7 is a schematic perspective view of the part of the side door, the door handle in a deployed position being removed, according to an embodiment;

FIG. 8 is a schematic perspective view of the part of the side door, the door handle being in a deployed position, according to an embodiment;

FIG. 9 is a schematic perspective view from above of a cover of the side door, according to an embodiment;

FIG. 10 is a schematic perspective view from below of the cover, according to an embodiment;

FIG. 11 is a schematic perspective view of the part of the side door, the door handle being in a deployed position, according to another embodiment;

FIG. 12 is a schematic front view of the door handle system, according to an embodiment; and

FIG. 13 is a schematic front view of the door handle system, according to another embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

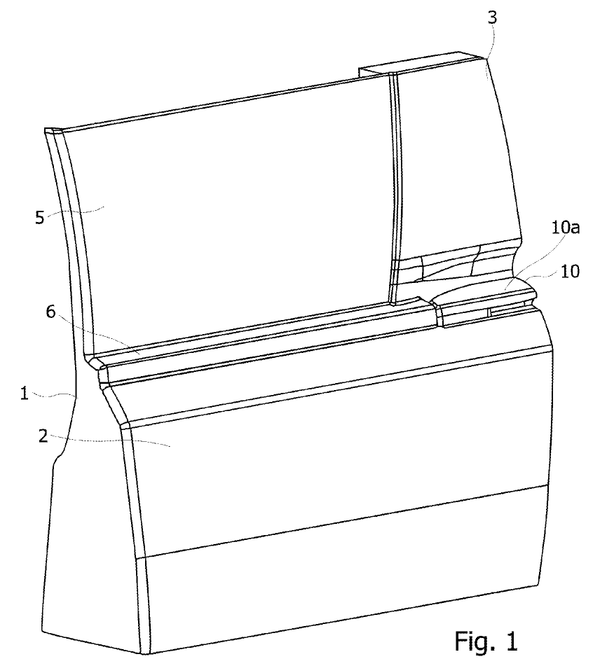

FIG. 1 shows a side part of a vehicle including a part of a side vehicle door 1. The door 1 as shown comprises a door panel 2, a window 5, a window lower belt 6 and a handle 10, and possibly a B-pillar 3. The handle 10 is shown in a retracted position. In this position, the handle 10 is mounted in the vehicle door 2 such that an outer surface 10a of the handle is flush with an outer surface of the window lower belt 6 of the vehicle door.

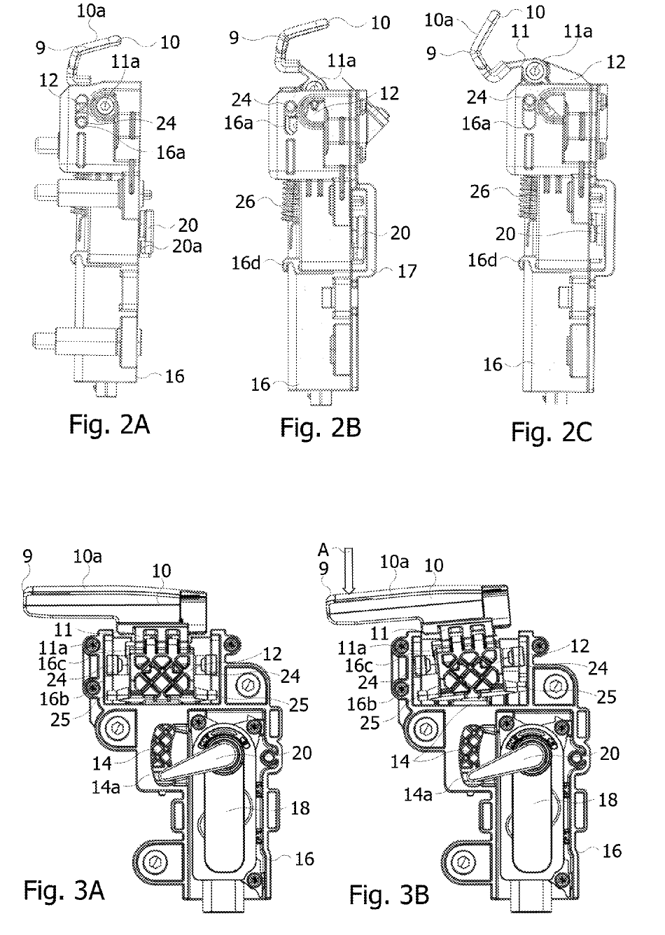

FIGS. 2A, 2B, 2C and 3A show a handle system coupled to the handle 10. The handle 10 comprises a grip element 9 and an attachment portion 11 which is fixed by a fixing element 11a such as a screw to an intermediate piece 12. The intermediate piece 12 comprises a pivot pin 24 and a guiding pin 25 parallel to the fixing element 11a. The intermediate piece 12 is mounted so as to be translationally and rotationally movable in a bracket piece 16. The bracket piece 16 also houses an actuator 18 coupled to a pivoting lever 20 for translating a link arm 14 bearing on the intermediate piece 12. The link arm 14 is slidingly housed in the bracket piece 16. The lever 20 is coupled with the link arm 14 by means of a pin 20a extending perpendicularly at a free end of the lever 20 and engaged in a slot 14a formed in the link arm 14. An elastic element 26, such as a spring, having an end fixed to the bracket piece 16 pulls and another end fixed to the intermediate piece 12, maintains the intermediate piece 12 against the link arm 14. The link arm 14 can have a substantially parallelepiped shape with an upper face bearing on a lower face of the intermediate piece 12 under the return force of the elastic element 26, the faces in contact of the intermediate piece 12 and the link arm 14 being parallel.

The bracket piece 16 comprises two opposite oblong openings 16a receiving a respective end of the pivot pin 24 of the intermediate piece 12. The bracket piece 16 further comprises two parallel cam surfaces on which ends of the guiding pin 25 of the intermediate piece 12 slide. Each of the cam surfaces comprises a linear part 16b and a curved part 16c. The bracket piece 16 can be closed by a cover 17.

As shown in FIG. 1, the outer surface 10a of the handle 10 is provided to be an external surface of the vehicle, facing outwardly. The outer surface 10a may thus be visible to a vehicle user and contribute to the general design of the vehicle. The outer surface 10a may be flat or may have a bent shape. In the illustrated embodiment, the outer surface 10a is in particular bent around a substantially longitudinal direction. Other configurations of the handle and/or shapes of the outer surface 10a are however possible.

The movement of the handle 10 is illustrated in FIGS. 2A, 2B, and 2C. FIG. 2A shows the handle 10 in a retracted (and lowest) position, also shown in FIG. 1. In this position, the pin 20a of the lever 20 and the link arm 14 occupy their lowest position. The ends of the pivot pin 24 of the intermediate piece 12 are also in their lowest position in the openings 16a of the bracket piece 16. The elastic element 26 pulls the intermediate piece 12 against the link arm 14. On the vehicle door 1, the outer surface 10a of the wing handle 10 in the retracted position is flush with an outer surface of the adjacent window lower belt 6. More precisely, these outer surfaces are aligned with each other towards a front of the vehicle. In other words, the wing handle 10 in the retracted position is comprised within a geometrical envelope defined by the outer profile of the adjacent window lower belt 6.

FIG. 2B, shows the handle 10 in an extended position. To reach this position from the retracted position, the actuator 20 rotates the lever 20 to move the pin 20a from its lowest position to a middle position. During this movement of the pin 20a, the link arm 14 is moved in translation and pushes the intermediate piece 12 upwards against the force exerted by the elastic element 26 until the ends of the pivot pin 24 reach the upper end of the openings 16a, whereas the ends of the guiding pins 25 slide along the linear part 16b of the cam surfaces, and the handle 10 with its attachment portion 11 and the fixing element 11a move upwards out of the bracket piece 16. Thus, the intermediate piece 12 and the handle 10 follow together a linear movement. In the extended position, the intermediate piece 12 can no longer move upwards since the ends of the pivot pin 24 reach the upper end of the openings 16a. The extended position is merely an intermediate position, and it is not intended that the door handle system stops deploying at this intermediary position or undergoes a break in this position.

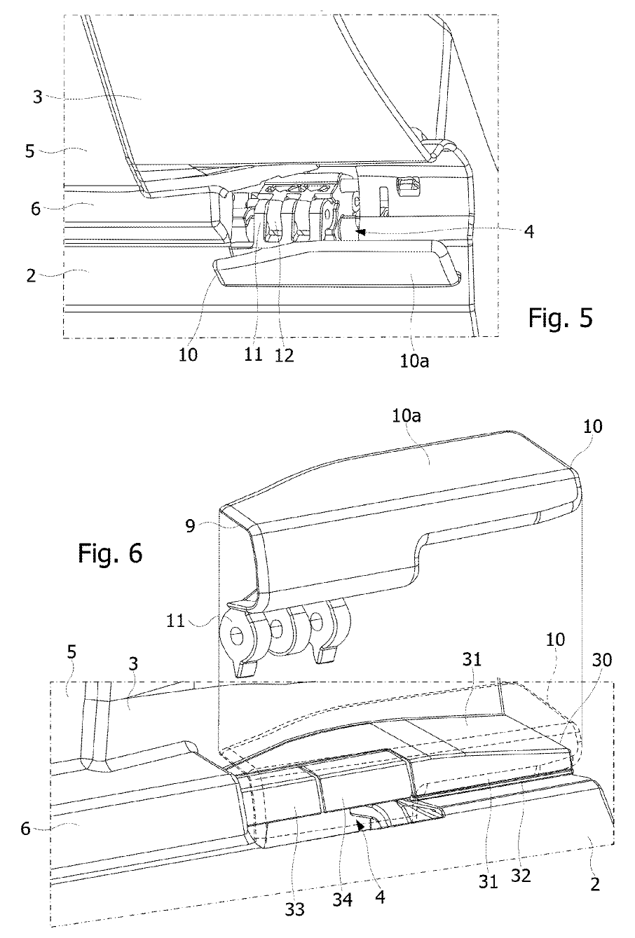

FIGS. 2C and 5 show the handle 10 in a deployed position. To reach this position from the extended position, the actuator 20 keeps rotating the lever 20 to move the pin 20a from its middle position to a highest position. During this movement of the pin 20a, the link arm 14 keeps pushing upwards the intermediate piece 12 which is blocked in translation by the pivot pin 24. During this movement of the link arm 14, the ends of the guiding pin 25 slide along the curved part 16c of the cam surfaces, which makes the intermediate piece 12 tilt about the pivot pin 24. This rotation movement of the intermediate piece 12 is made possible due to an offset between the pins 24 and 25. The rotation of the intermediate piece 12 makes the handle 10 swivel with its attachment portion 11 to the deployed position. When the actuator 18 reaches an end position, the lever 20 stops rotating, the link arm 14 stops translating, and the intermediate piece 12 and the wing handle 10 stop rotating around the pivot pin 25. Abutments can be provided to inhibit the pin 25 from pivoting too far around the pivot pin 24. At that point, the wing handle 10 is in the deployed position in which the handle protrudes outwardly and thus can be easily grasped by a user to be manually operated to open the vehicle door 1.

In order to open the vehicle 1, the user has to pull onto the wing handle 10. Upon pulling the wing handle 10, the user applies an outward force onto a grabbing portion 9 of the handle. The wing handle 10 and the intermediate piece 12 pivot outwardly around pivot pins 24. Thereby, the intermediate piece 12 elastically deforms which deformation can be detected by a sensor such as strain gauge (not shown). The strain gauge can be configured to send a door unlocking signal to a control unit ECU (Electronic Control Unit, not illustrated) of the vehicle, whereby the vehicle door unlocks.

Once the need to operate the vehicle door 1 disappears, e.g., when the user starts the vehicle, or if the control unit in the vehicle detects that the door is closed and that the user moved away from the vehicle, the vehicle door handle system may receive a retraction order to bring the wing handle 10 back from the deployed position to the retracted position. Over such a retraction of the wing handle, the lever 20 may be moved back into its lowest position together with the link arm 14, and the elastic element 26 may pull back the intermediate piece 12.

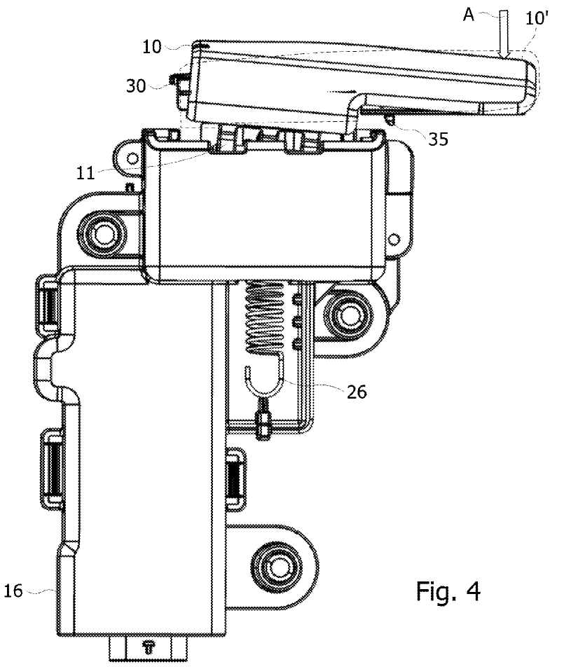

As shown in FIGS. 3A, 3B and 4, the handle 10 and the intermediate piece 12 to which the handle 10 is fixed are movable in translation in the bracket piece 16, and in rotation about an axis parallel to the fixing element 11a. The intermediate piece 12 with the handle 10 are urged downwards against the link arm 14 by the elastic element 26. Therefore, a pressure exerted on the outer surface 10a of the handle 10 near the free end thereof (according to the arrow A as shown in FIGS. 3B and 4) makes the handle 10 with the intermediate piece 12 tilt downwards, i.e. pivot about an axis substantially parallel to the rotation axis of the actuator 18. Thus, when the handle is blocked due the presence of ice in winter conditions, the user can break the ice merely by pushing the free end of the handle downwards or pulling the latter upwards, against the elastic force exerted by the elastic element 26. This movement is possible thanks to the mechanical link between the handle 10 and the actuator 18 enabling the translation upwards and downwards of the handle. When the user removes his hand from the handle, the latter return to its rest position (as shown in FIG. 3A) under the elastic force exerted by the elastic element 26.

The arrangement of the wing handle system inside the door 1, with the wing handle 10 outside the door, requires the provision of an upward opening 4 in the door panel under the wing handle 10 when the latter is in the retracted position, as shown in FIG. 5. When the wing handle 10 is in its intermediary or deployed position, the opening 4 become visible with the upper parts 11, 12 of the wing handle system, which has a negative aesthetic effect. In addition, due to the presence of the opening 4, foreign bodies such as dust and small objects can be inserted into or fall through the opening 4 inside the vehicle door 1, which can damage electrical or mechanical parts of the wing handle system.

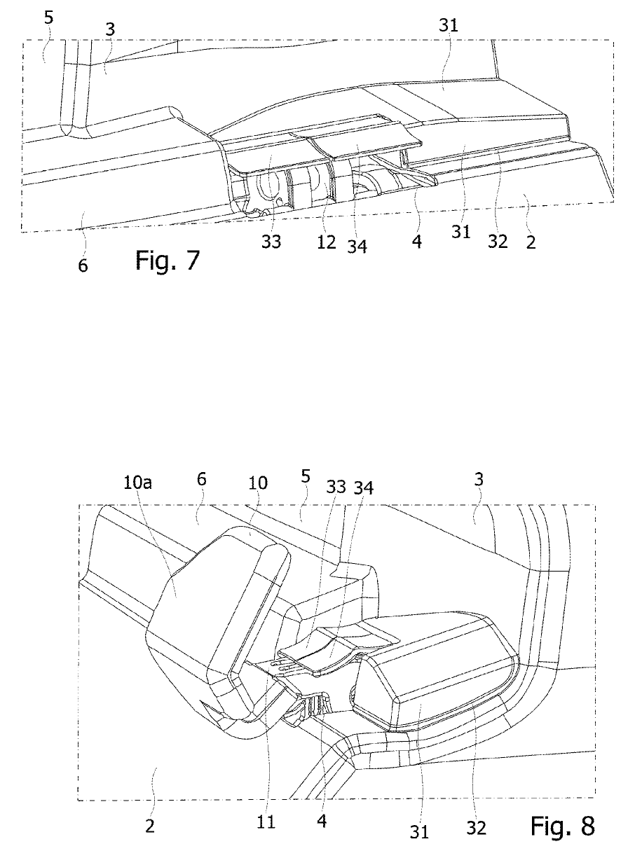

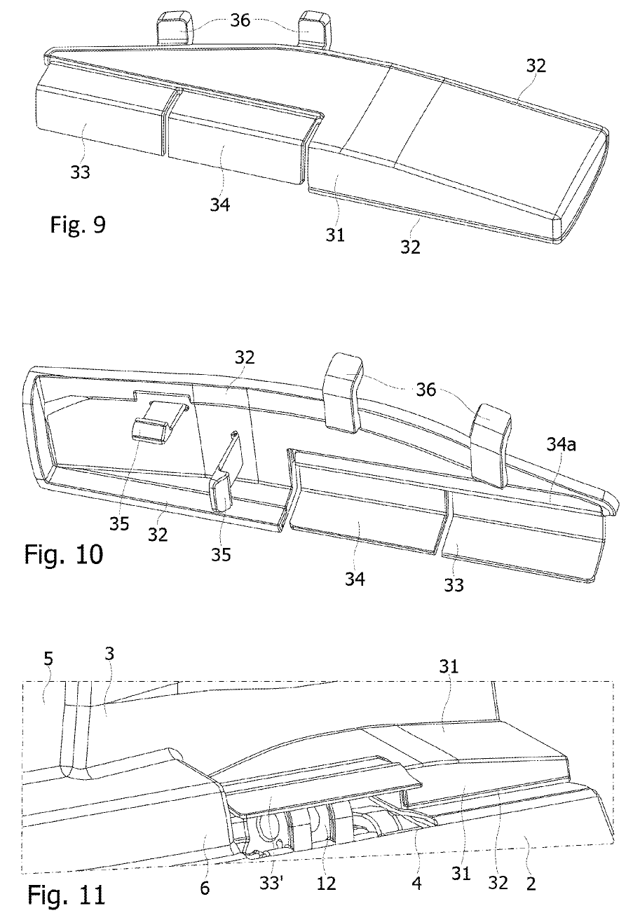

FIGS. 6, 7 and 8 show a part of the side door 1, according to an embodiment. In FIG. 6, the door handle 10 is shown in a retracted position spaced apart from the side door, the final position of the door handle being shown with a dashed-line contour. The door handle 10 is removed in FIGS. 7 and 8 shows the door handle 10 in its deployed position. The wing handle system comprises a cover 30 hiding the opening 4 and a surface of the door panel 2 below the door handle 10. The cover 30 is shown in more details in FIGS. 9 and 10. The cover 30 comprises a rigid part 31, one or more flexible flaps 33, 34 fixed to the rigid part 31 and a soft gasket 32 along the edges of the rigid part 31 which are intended to be in contact with the door panel 2. The rigid part 31 comprises clips 35 and hooks 36 to fix the cover 30 to the door 1 in position on the opening 4, the gasket 32 being pressed between the rigid part 31 and the door panel 2. The flaps 33, 34 are arranged to allow the wing handle system to move between its retracted and deployed positions.

FIGS. 6, 9 and 10 show the flaps 33, 34 in a rest position when the wing handle 10 is in its retracted position. FIGS. 7 and 8 show the flaps 33, 34 in a raised position reached when the wing handle 10 is in its intermediary or deployed position, the flaps being raised by the attachment portion 11 of the wing handle 10. Thanks to its structure and arrangement, the cover 30 inhibits foreign objects from being inadvertently introduced through the opening 4 into the door 1.

The cover 30 can be manufactured by overmolding the flaps 33, 34 and the gasket 32 on the rigid part 31. The rigid part 31 can be made of a rigid thermoplastic such as such as polypropylene or polyamide. The flaps 33, 34 and the gasket 32 can be made of a soft elastomer such as such as a thermoplastic elastomer TPE, for example UV resistant. The flaps 33, 34 can made in a single piece, the flaps being linked together by a common part 33a which is fixed to the rigid part 31.

According to another embodiment illustrated in FIG. 11, the cover 30 comprises a single flexible flap 33’ to cover the opening 4 (having the surface of the two flaps 33, 34).

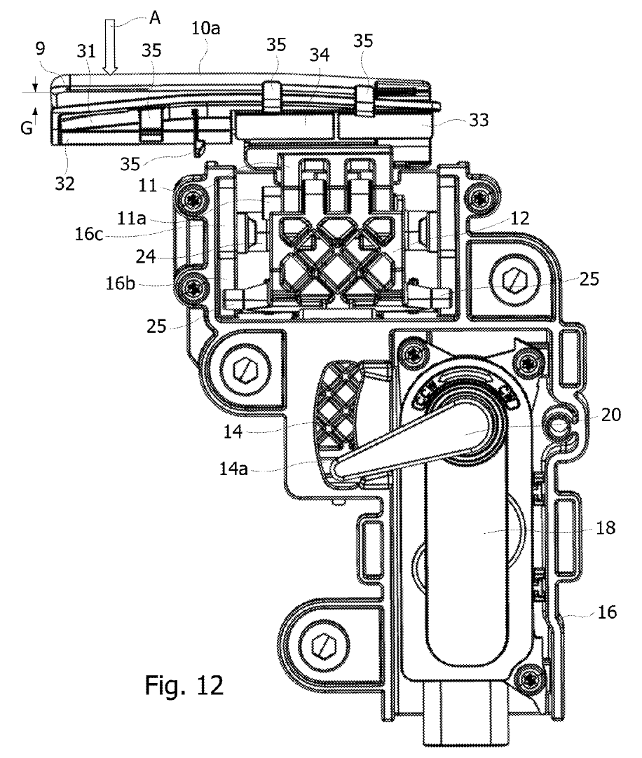

As shown in FIG. 12, the grip element 9 of the handle is spaced from the rigid part 31 of the cover 30 by a gap G when the handle is in its retracted position. This gap is sufficient to enable the handle to be pushed downwards (according to arrow A) to release the handle 10 when the latter is blocked by ice.

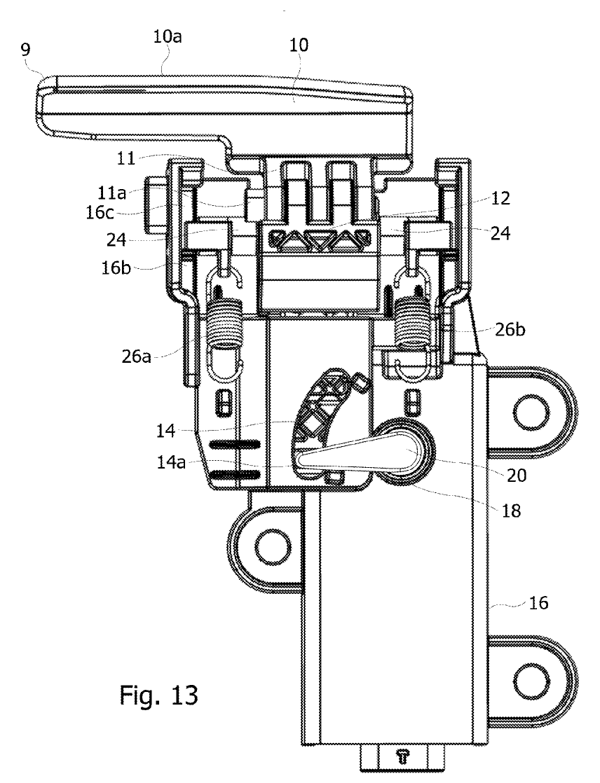

FIG. 13 shows a door handle system according to another embodiment. This embodiment differs from the previous embodiments in that the handle 10 fixed to the intermediate piece 12 are urged against the link arm 14 by two elastic elements 26a, 26b each having one end fixed to the intermediate piece 12 and one end fixed to the bracket piece 16. The two elastic elements 26a, 26b are spaced apart such that when the free end of the gripping element 9 of the handle 10 is pushed downwards by the user, only one (26b) of the elastic elements is elastically extended, and when the free end of the gripping element 9 is pulled upwards, the other one (26a) of the elastic elements is elastically extended.

The above description of various embodiments is provided for purpose of description to one of ordinary skills in the related art. It is not intended to be exhaustive or to limit the scope of the present disclosure solely to the disclosed embodiments. Numerous alternatives or variations to the present disclosure will be apparent to those of ordinary skills in the related art. Accordingly, while some alternatives or embodiments have been presented specifically, other embodiments will be apparent or easily developed by those of ordinary skills in the related art. Limitations in the appended claims should be interpreted broadly based on the language used in the claims and such limitations should not be restricted to the specific examples described above.

In this respect, it is apparent to those of ordinary skills in the related art that the advantages described in the present disclosure can be obtained with other structures of the wing handle. Thus, the wing handle is not necessarily movable both in translation and rotation and does not have necessarily an intermediate extended position. Moreover, the handle can be operated only manually.

In addition, the cover 30 can be realized in a soft material, such that it can be formed in a single piece with the flaps and the gasket. Also other fixations elements of the cover can be provided. In fact, the use of clips merely simplifies the mounting of the cover on the door opening 4, which can be performed in by positioning the cover on the opening and by exerting a pressure on the cover.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle door comprising:
a window lower belt,
an opening, and
a door handle system comprising a wing handle movable between a retracted position and a deployed position, wherein:
in the retracted position, the wing handle is configured to be at least partially retracted through the opening in the vehicle door, the wing handle having an outer surface configured to be flush with an outer surface of the window lower belt,
in the deployed position, the wing handle is configured to be protruding outwardly from the opening with respect to the outer surface of the window lower belt, and
the door handle system further comprises an intermediate piece fixed to the wing handle and an actuator for moving in translation a link arm which is urged against the intermediate piece by an elastic element, such that a free end of the wing handle in its retracted position is movable in rotation against an elastic force exerted by the elastic element.

2. The vehicle door of claim 1, wherein the door handle system comprises an actuator configured to cause the wing handle to move between the retracted position and the deployed position, a movement of the wing handle between the retracted position and the deployed position comprising a translation movement between the retracted position and an intermediate extended position and a rotation movement between the intermediate extended position and the deployed position.

3. The vehicle door according to claim 1, further comprising a cover fixed to and closing at least partially the opening, the cover comprising a rigid part, at least one flexible flap fixed to the rigid part, the at least one flexible flap having a rest position when the wing handle is in the retracted position and a raised position, the at least one flexible flap being raised by the wing handle when the wing handle is moved to the deployed position.

4. The vehicle door according to claim 3, wherein the wing handle comprises a grip element disposed in the retracted position so as to form a gap (G) between the grip element and the cover, the wing handle being urged in the retracted position by an elastic element.

5. The vehicle door according to claim 3, wherein the cover comprises a rigid part to which the at least one flexible flap is fixed.

6. The vehicle door according to claim 5, wherein the cover is formed by overmolding the at least one flexible flap on the rigid part.

7. The vehicle door according to claim 3, wherein the cover comprises a soft gasket placed against the vehicle door.

8. The vehicle door according to claim 3, wherein the cover comprises clips and/or hooks to fix the cover to the vehicle door in position on the opening.

9. A vehicle comprising at least one vehicle door according to claim 1.
